(19) United States
(12) Patent Application Publication
(10) Pub. No.: US 2014/0279921 A1
(43) Pub. Date: Sep. 18, 2014

(54) System and Method of Deletion and Backup of Social Networking Generated contents

(71) Applicant: Mark Wallace Wolfgang, Cocoa Beach, FL (US)

(72) Inventor: Mark Wallace Wolfgang, Cocoa Beach, FL (US)

(21) Appl. No.: 14/217,084

(22) Filed: Mar. 17, 2014

Related U.S. Application Data
(60) Provisional application No. 61/801,909, filed on Mar. 15, 2013.

(51) Int. Cl. G06F 11/14

(52) U.S. Cl. CPC G06F 11/1458
USPC 707/654

(57) ABSTRACT

A system and method is provided to programmatically backup and delete social networking generated (SNG) contents of a user generated by social networking activities conducted through a social network provider (SNP) with which the user has an account. The system comprises means for setting criteria for target SNG contents to be either backed-up or deleted. The criteria include at least one timeframe criterion and content type criterion. The system further comprises execution means for programmatically downloading or deleting the target SNG contents stored in the SNP. The system further comprises means for invoking the execution means.

### CROSS-REFERENCE TO RELATED APPLICATION

This application claims the benefit under 35 U.S.C. §119(e) of Provisional Patent Application No. 61/801,909, filed Mar. 15, 2013, the entire disclosure of which is hereby incorporated by reference.

### BACKGROUND

1. Technical Field

The present disclosure generally relates to a system and method of deletion and backup of online-based user content. The present disclosure more particularly relates to a system and method of deletion and backup of contents generated by online social networking activities.

2. Description of the Related Art

Online social networks, such as Facebook and LinkedIn, have become increasingly popular among users of diversified demographics. In an online social network, a user can post pictures, videos and status comments, respond to friends' postings, send messages to friends, receive messages from friends, perform online text chats, and so on. Almost all of those activities generate contents. With the passage of time, a user's content volume can quickly grow.

At times, a user may prefer to delete or backup some or all of the user's contents generated within a social network for various personal reasons. Major social network providers (“SNPs”), which although may provide some mechanisms for a user to delete the user's contents, do not provide mechanisms to let a user delete multiple content objects at once or enable a user to perform automatic deletion of selected contents based on a user-preferred schedule. This makes it very difficult for a user to delete the user's own content items. For example, in Facebook, it usually requires 6 mouse clicks for a user to untag himself or herself in pictured posted by a “friend” of the user, 6 mouse clicks for a user to permanently delete a personal message, and 4 mouse clicks to delete a wall post. As a result, often against a user's will, major social network providers cause extraordinary inconvenience for a user to delete the user's own contents.

Additionally, major social network providers do not provide mechanisms to let a user backup his or her contents on the user's own computer in a systematic and non-piecemeal fashion, resulting in the user being forced to log into a social network in order to view the user's own contents.

Therefore, there is a need for a system and method that enables a user to conveniently delete and backup the user's own contents generated by the user's on-line social networking activities.

### BRIEF SUMMARY

In one aspect, the present disclosure provides a system and method that allows a user to select the user's own SNG contents for deletion and/or backup. In particular, the system and method enables a user to select, from among a list of commonly generated types of contents, contents that the user want to be deleted and/or backed up. Additionally, the system and method enables the user to specify one or more time periods during which the types of contents selected for deletion and/or backup were generated. Once the user-selected contents for deletion and/or backup are determined, the system proceeds to carry out the deletion programmatically. This results in the user being spared of otherwise performing countless mouse clicks in order to delete just few of the user's SNG contents.

In another aspect, the present disclosure provides a system and method that enables fully automated and regularly scheduled deletion and/or backup of a user's SNG contents, so that the user is assured of timely deletion and/or backup of the user's same contents. This results in the user feeling confident that the availability, provision and disposal of the user's personal contents is no longer only at the mercy of social network providers while freely conducting normal and regular social networking activities.

In yet another aspect, the present disclosure provides a system that backs up a user's SNG contents, stores the backed-up contents in the system's data store, and provides mechanisms to allow the user to download the stored backup contents from the system to the user's own storage device for the user's personal viewing.

In yet another aspect, the present disclosure provides a system that, in one embodiment, programmatically deleting or backing-up a user's SNG contents by logging into the user's social network account of a social network provider on behalf of the user, retrieving and parsing one or more web pages as needed, and simulating mouse clicks used to delete or receive target contents by sending web requests to the same effects to a social network provider.

The above summary contains simplifications, generalizations and omissions of detail and is not intended as a comprehensive description of the claimed subject matter but, rather, is intended to provide a brief overview of some of the functionality associated therewith. Other systems, methods, functionality, features and advantages of the claimed subject matter will be or will become apparent to one with skill in the art upon examination of the following figures and detailed written description.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1 is a general block diagrams illustrating an exemplary environment for deleting or backing up SNG contents, according to one or more embodiments of the present disclosure.

FIG. 2 is a block diagrams illustrating an exemplary client device 101, according to one or more embodiments of the present disclosure.

FIG. 3 is a block diagram illustrating backend system 102 according to one or more embodiments of the present disclosure.

FIG. 4 is a flowchart exemplifying a process through which a user can have SNG contents of the user's choosing deleted and/or backed up, according to one or more embodiments of the present disclosure.

FIGS. 5A-5L are exemplary UIs provided in connection with blocks exemplified in FIG. 4, according to one or more embodiments of the present disclosure.

FIGS. 6A-6C are flowcharts illustrating exemplary implementations of block 406 provided in FIG. 4, according to one or more embodiments of the present disclosure.

### DETAILED DESCRIPTION

In the following detailed description of exemplary embodiments of the disclosure, specific exemplary embodiments in which the disclosure may be practiced are described in sufficient detail to enable those skilled in the art to practice the disclosed embodiments. For example, specific details such as specific method orders, structures, elements, and connections have been presented herein. However, it is to be understood that the specific details presented need not be utilized to practice embodiments of the present disclosure. The following detailed description is, therefore, not to be taken in a limiting sense, and the scope of the present disclosure is defined by the appended claims and equivalents thereof.

References within the specification to “one embodiment,” “an embodiment,” “embodiments”, or “one or more embodiments” are intended to indicate that a particular feature, structure, or characteristic described in connection with the embodiment is included in at least one embodiment of the present disclosure. The appearance of such phrases in various places within the specification are not necessarily all referring to the same embodiment, nor are separate or alternative embodiments mutually exclusive of other embodiments. Further, various features are described which may be exhibited by some embodiments and not by others. Similarly, various requirements are described which may be requirements for some embodiments but not other embodiments.

The terminology used herein is for the purpose of describing particular embodiments only and is not intended to be limiting of the disclosure. As used herein, the singular forms “a”, “an” and “the” are intended to include the plural forms as well, “or” includes “and/or,” and reference to a numerical value includes at least that value, unless the context clearly indicates otherwise. Moreover, the use of the terms first, second, etc. do not denote any order or importance, but rather the terms first, second, etc. are used to distinguish one element from another.

Functional steps illustrated herein, unless otherwise specified as, or logically required to be, performed in accordance with a specific sequence, are presumed to be performable in any order without regard to a specific sequence.

Within the descriptions of the different views of the figures, the use of the same reference numerals and/or symbols in different drawings indicates similar or identical items, and similar elements can be provided similar names and reference numerals throughout the figures. If a reference numeral is once used to refer to a plurality of like elements, unless required otherwise by context, the reference numeral may refer to any, a subset of, or all of, the like elements in the figures bearing that reference numeral. The specific identifiers/names and reference numerals assigned to the elements are provided solely to aid in the description and are not meant to imply any limitations (structural or functional or otherwise) on the described embodiments.

In the description, relative terms such as “left,” “right,” “vertical,” “horizontal,” “upper,” “lower,” “top” and “bottom” as well as any derivatives thereof (e.g., “left side,” “top bar,” and etc.) should be construed to refer to the logical orientation as then described or as shown in the drawing figure under discussion. These relative terms are for convenience of description and are not intended to convey any limitation with regard to a particular orientation.

In the present disclosure, the terms “module”, “sub-module”, “application”, “application module”, “software”, “software program”, “software module”, “programmatic module”, “code”, “application code”, “programmatic code”, “object”, “programmatic object”, “script”, “routine”, “service routine”, “function”, “service”, “engine”, “processor”, “component”, and so on, when context allows, may be used interchangeably to refer to one or more sets of computer instructions adapted to perform, when executed by a processor (such as a microprocessor or a microcontroller), one or more specific functions.

With reference now to the figures, and beginning with FIG. 1, there is depicted a general block diagrams illustrating an exemplary environment for deleting or backing up SNG contents, according to one or more embodiments of the present disclosure.

Referring to FIG. 1, each of backend system 102 and social network providers 103 (such as social network providers 103A and 103B) are communicatively coupled to a plurality of network-capable client devices 101 through one or more communication networks 105, which may include Internet and/or one or more interconnected networks, such as one or more cellular networks, or one or more local area networks. Backend system 102 is an exemplary system implemented to enable a user to delete or back up the user's contents generated by the user's social networking activities. Backend system 102 is communicatively coupled to social network providers 103 (such as social network providers 103A and 103B) via communication networks 105.

A user may user one or more client devices 101 to join any social network provider 103 and perform social networking activities through one or more social network providers 103. Examples of popular social network providers 103 include Facebook and LinkedIn. Social networking activities performed within a social network, as well known, may include posting photos and videos, posting status updates, posting comments to other user's postings of images and updates, sending and receiving messages, tagging users into pictures, and so on.

FIG. 2 is a block diagrams illustrating an exemplary client device 101, according to one or more embodiments of the present disclosure. A client device 101, as shown in FIG. 2, can be any computing device having networking capabilities and loaded with one or more client applications. Examples of a client device 101 may include a smart phone, a PC, a notebook computer, a tablet and a PDA. Referring to FIG. 2, a client device 101 may comprise, inter alia, input module 201, one or more processors 202, communication module 203, system memory 204 (which may include operating system 205 and client application 206), display module 210 and storage module 220.

Examples of processor 202 include a microprocessor and a microcontroller. Input module 201 receives input from a user and provides the received input to processor 202 for further processing by software programs running in processor 202. Input module 202 may include a keyboard, a mouse, input keys, a touch screen, a touchpad, or any combination thereof. Communication module 203 provides wired and/or wireless networking capabilities with one more communication devices included therein, such as network interface device (NID), an RF unit, and antenna, or any combination thereof.

One or more software or firmware modules can be loaded into system memory 204 during operation of the client device 101. These software or firmware modules, when executed by processor 202, are adapted to perform various functions for which their respective programmatic codes are programmed. Thus, in one embodiment, system memory 204 may include operating system 205 and one or more applications 206, which may work in concert with backend system 202 to implement deletion and/or backup of SNG contents of a user.

Applications 206 are commonly referred to as “apps” when the client device 204 is a smart mobile device such as a smart phone or a tablet PC. In one embodiment, applications 206 may include a web browser, which renders HTML pages received from backend system 102. In another embodiment, applications 206 may include one or more custom applications specifically programmed to provide custom user interfaces (UIs). A custom application 206 may exist in various forms. For example, a custom application 206 may be a standalone application running in a smart phone, a tablet, PC and notebook computer. A custom application 206 may also be a software module running inside a specific application context, such as a so-called “Facebook app” running inside a Facebook context.

Either the UIs rendered inside the HTML pages sent by backend system 102, or the custom UIs provided by a custom application 206, are designed to allow the user to interact with backend system 102 so as to materialize deletion and/or backup of SNG contents of the user. Thus, for the ease of discussion, hereinafter, client application 206 refers to any of a web browser, one or more aforementioned custom applications adapted to provide the custom UIs, or any combination thereof.

Display module 210 may include a display device, such as an LCD display screen, that is used to display user input data or output data provided by an application running in client device 101. Display module 210 may include a touch screen which allows user to input data. In that case, display module 210 may also serve as an input device included in input module 201.

Storage module 220 may include various internal and external storage media, such as RAM, ROM, hard disk, smart card, flash memory, and any external storage accessible via, e.g., communication module 203 or various interface modules (not shown) of client device 101, such as USB interfaces. For example, an external storage device or a distributed file system, either of which is located in a different domain or network from client device 101, is considered part of storage module 220 if either can be accessed for storage by the client device 101 via, e.g., communication module 203 using standard or proprietary communication protocols.

FIG. 3 is a block diagram illustrating backend system 102 according to one or more embodiments of the present disclosure. Referring to FIG. 3, backend system 102 comprises server 301 and data store 302. As used herein, the term “server” refers to any of various types of computing devices, such as computer clusters, server pools, general-purpose personal computers, workstations, or laptops. Also, the term “backend system 102”, depending on the context in which the term is mentioned, may also refer to an entity (such as an owner or an operator) owning and/or operating backend system 102.

Server 301 comprises, inter alia, one or more processors 306 (such as one or more microprocessors), one or more network interface devices 307, and one or more system memories 308. During operation of server 201, software modules or firmware modules, such as operating system 309 and a plurality of application modules 310, are loaded into system memories 308. These software or firmware modules, when executed by processor 202, are adapted to perform various functions for which their respective programmatic codes are programmed.

Data store 302 (hereinafter referred to as “DS 302”) is communicatively coupled to server 301. DS 302 may exist or be implemented in one or more of various forms, such as one or more relational or objective databases, one or more local or distributed file systems, one or more removable storages, one or more memory caches, one or more memory clusters, or any combination thereof. In embodiment, DS 302 resides in server 301. In another embodiment, DS 302 resides external to server 301.

Application modules 310 may be implemented in various forms, such as executable programs, callable functions and routines, scripts that can be executed via running of one or more interpreter programs, services that may be invoked by standard or proprietary protocols, and programmatic objects containing both data and callable functions. In one embodiment, application modules 310 may include web server module 311, user sign-up module 312, social network content selection module 313, social network authentication module 314, social network content deletion module 315, social network content backup module 316, and task scheduler 317.

Web server module 311 is programmed and configured to receive web requests from client application 206 (such as a web browser) of a client device 101 and delivers a corresponding web response to client application 206. User sign-up module 312 is programmed and configured to process a sign-up request of a user as needed. Social network content selection module 313 is programmed and configured to process a user's selections of SNG contents for deletion and/or backup. Social network authentication module 314 is programmed and configured to perform social network login on behalf of a user using login credentials provided by the user. Social network content deletion module 315 and Social network content backup module 316 are programmed and configured to perform deletion and backup of user-selected SNG contents on behalf of a user, respectively. Task scheduler 317 is programmed and configured to schedule the execution of one or more pre-defined tasks, such as deleting or backing up user-selected SNG contents, based on pre-defined execution schedules.

Some of application modules 310 are also programmed and configured to generate specific UI instructions (which may include both presentation semantics and data to be displayed). Typically, these UI instructions would be subsequently provided to client application 206 by backend system 102 (through, for example, web server module 311) via one or more communication channels between a client device 101 hosting client application 206 and backend system 102. For example, if client application 206 is a web browser, some of application modules 310 may be also programmed and configured to generate specific HTML pages (as UI instructions) intended for client application 206 to render one or more UIs based thereon. Thus, for illustration and not limitation, user sign-up module 312 may generate UI instructions to render one or more UIs to allow a user to sign up with backend system 102. Social network content selection module 313 may generate UI instructions to render one or more UIs to enable a user to select SNG contents of the user which the user chooses to delete and/or backup.

FIG. 4 is a flowchart exemplifying a process through which a user can have SNG contents of the user's choosing deleted and/or backed up, according to one or more embodiments of the present disclosure. As used herein, the terms “block” and “step” may be used interchangeably to refer to a set of programmatic code adapted to perform one or more specific functions when executed by a processor.

At block 401, a user signs up (or, in other words, registers) with backend system 102. Specifically, client application 206 may render one or more UIs for the user to sign up with backend system 102. Client application 206 may render the one or more UIs in accordance with corresponding UI instructions (such as HTML pages) provided from backend system 102. In one implementation, the user is prompted to create user name and password as the user's login credentials (via the one or more presented UIs).

Alternately or additionally, the user is prompted to register with backend system 102 via the user's authentication to a social network provider, such as Facebook or LinkedIn. After the user's successful authentication to the social network provider, backend system 102 (or client application 206) may receive an authentication, access or session token (hereinafter referred to as “access token”), through which backend system 102 (or client application 206) may access some or all of the user's personal and social network information stored in the social network provider (via, e.g., user sign up module 312). The acquiring of the user's personal information and social network information may spare the user of manually providing the same set of information to backend system 102 via additional forms. The access token, as provided by a social network provider, may be of permanent or extended duration. Thus, the access token, when provided to backend system 102 by client application 206, may be used by backend system 102 on a permanent or extended basis to programmatically access, delete, and/or backup the user's social networking contents generated in the social network provider on behalf of the user.

At the same block 401, the user may also provide, to backend system 102, information that enables backend system 102 to access the user's SNG contents. For example, the user may provide the user's login credentials for a social network provider—such as the user's user name (which may be an e-mail address of the user) and password which the user uses to log into the social network provider—to backend system 102 via one or more user interfaces displayed by client application 206. With the possession of the user's login credentials for a social network provider, backend system 102 may log into the social network provider on behalf of the user, and performs deletion and/or backup on behalf of the user.

At block 402, a user selects the user's SNG contents targeted for deletion and/or backup (referred to hereinafter “target SNG contents”). Specifically, client application 206 may render one or more UIs for the user to select target SNG contents, and provide the user's selection information to backend system 102. Client application 206 may render the one or more UIs in accordance with corresponding UI instructions (such as HTML pages) received from backend system 102.

The one or more UIs presented by client application 206 let the user select a subset of the user's SNG contents by letting the user set a plurality of criteria used to define target SNG contents. By way of example and not limitation, a first criterion (referred to hereinafter “the content type criterion”) includes one or more types of target SNG contents (or, in some social network providers' term, “objects). A second criterion (referred to hereinafter “timeframe criterion”) includes one or more timeframes during which target SNG contents are generated. In particular, the included timeframes do not have to be ones in the past, but can be ones in the future. Including one or more future timeframes in the timeframe parameter allows backend system 102 to schedule for future automatic deletion and/or backup of a user's SNG contents on behalf of the user.

For illustration and not limitation, FIGS. 5A-5H are exemplary UIs that client application 206 may display for the user to materialize selections of SNG contents for deletion and/or backup. FIG. 5A shows an exemplary UI that provides a user with one-time or generic deletion and/or backup generic options. As shown, the user may select one of “BOMB”, “TIMEBOMB” and “SAVE” generic options. As indicated, the “BOMB” and “SAVE” options provide one-time deletion and backup (of the user's SNG contents) functionalities, respectively. The “TIMEBMOB” option provides recurring deletion and/or backup functionalities.

Regardless of which one of the three generic options that the user selects via the UI shown in FIG. 5A, the user is prompted to provide selections for the above-noted content type and timeframe criteria (following the selection of a generic option). By way of example and not limitation, FIGS. 5B-5E show exemplary UIs that allow a user to provide selections on the content type and timeframe criteria.

Specifically, FIG. 5B shown an exemplary UI provided to let the user select one or more content types for target SNG contents. By way of example and not limitation, as shown, known types of SNG contents may include “wall posts”, “activities”, “messages”, “pictures”, “events”, “comments”, “questions”, “tags”, and etc. Thus, through UI elements shown in FIG. 5B, the user may set the content type criterion for target SNG contents.

FIGS. 5C-5E show exemplary UIs presented to let a user set the timeframe criterion for selecting target SNG contents. UIs shown in FIGS. 5C and 5E let the user specify one or more time periods, such as a time period between two dates during which applicable SNG contents—referring to contents which also meets other content selection criteria such as the content type criterion—were generated. Additionally, UIs shown FIGS. 5C, 5D and 5E also let user specify a time length (such as 6 months), older than which the user would like to delete and/or backup applicable SNG contents. In particular, the time length specified in either FIG. 5D or FIG. 5E is also used to schedule automated deletion and/or backup, such that applicable SNG contents older than the time length, as of any future date (in addition to as of the current date), will be automatically deleted or backed-up. Furthermore, for both deletion and backup of SNG contents, UIs shown in each of FIG. 5D and FIG. 5E—which are tied to either the one-time generic option “BOMB” or the one-time option “SAVE”—also include an option that allows the user to either delete or back up all applicable SNG contents without regard to any timeframe. Thus, through UI elements shown in one or more of FIGS. 5C-5E, the user may set the timeframe criterion for target SNG contents.

As shown in FIGS. 5C, 5D and 5E, the user may select additional options, such as “backup before delete” or “email me when finished”, as applicable to deletion and/or backup of a user's SNG contents. A skilled artisan appreciates that there may be other UI input elements that client application 206 may display (on behalf of backend system 102) in connection with other one or more criteria used to define or select target SNG contents, without departing from the scope and spirit of the present application. For example, client application 206 may further display UI input elements prompting and enabling the user to enter one or more key words or regular expressions which target SNG contents must contain or match, as a way to let user set an additional “key word” criterion used to define or select target SNG contents.

Following the user's selections of target SNG contents (via, e.g., UIs shown in FIGS. 5A-5E), client application 206 may display one or more summary screens summarizing the user's selections before those selections take effect. FIGS. 5F-5H show exemplary summary screens displaying UIs summarizing the user's selections of target SNG contents. After the user's confirmation of the selections (by, e.g., clicking the “Finish” button on each summary screen), client application 206 communicates the user's selections to backend system 102.

At block 403, backend system 102, upon receiving the user's selections (via, e.g. web server module 311), creates one or more one-time and/or recurring tasks of deletion and/or backup of the user's SNG contents based on received selections of the user (via, e.g., social network content selection processing module 313). Backend system 102 may store information (data) about the user's selections as well as information (data) about the created tasks in DS 302. Some of the created tasks (referred to hereinafter as “ready-to-be-executed tasks”) may need to be executed at the earliest possible time. Examples of those ready-to-be-executed tasks may include one or more one-time tasks resulting from a selection of either the “BOMB” option or the “SAVE” option, and/or one or more first-to-be-executed tasks of a series of recurring tasks resulting from a selection of the “TIMEBOMB” option. Backend system 102 may choose to immediately queue those waiting-to-be-executed tasks in an execution queue. Backend system 102 may further provide visual progress indications, as exemplified in FIG. 51, with regard to creation of tasks and the queuing of ready-to-be-executed tasks via one or more UI elements (such as progress bars) displayed by client application 206.

At block 404, backend system 102 schedules for execution some or all of the tasks created at block 403 (via, e.g., task scheduler module 317). Specifically, backend system 102 may choose to schedule for execution those ready-to-be-executed tasks created at block 403, rather than queue those ready-to-be-executed tasks in an execution queue. Additionally, backend system 102 may schedule for execution recurring tasks created at block 403. Backend system 102 may further store scheduling-related data—such as tasks that have been scheduled for execution, respective scheduled execution dates for scheduled tasks and status information about scheduled tasks (such as whether the scheduled task has been completed)—in DS 302. Upon a user's request (via one or more UI elements displayed by client application 206), backend system 102 may retrieve from DS 302 scheduling-related data and provide the retrieved data for viewing via one or more UIs displayed by client application 206. FIG. 5J shows an exemplary UI displaying scheduling-related data.

Optionally, at block 405, if a scheduled deletion or backup task has not been executed, the user may cancel the task via one or more UI elements displayed by client application 206. Specifically, UI elements displaying scheduling-related data, as either provided by backend system 102 via UI instructions sent to client application 206 or by client application 206, may be so configured that the UI elements allow the user to cancel one or more scheduled but unexecuted deletion or backup tasks. The exemplary UI shown in FIG. 5 contain such UI elements. As shown, for each scheduled task that has not been executed, a “cancel” button is provided to enable the user to send a request to backend system 102 that the user would like to cancel the scheduled task. Backend system 102, upon receiving the canceling request, cancels the scheduled task (via, e.g. task scheduler module 317). The cancellation may be performed by removing the scheduled task from a task queue (if the scheduled task has been already put in the queue), and/or removing or updating one or more corresponding scheduling-related data entries in DS 302.

At block 406, backend system 102 executes a task of deletion and/or backup of applicable SNG contents of a user. Block 406 may be invoked, e.g., when the task (executed therein) has been pushed out of the task queue for execution, or when the scheduled date or time for execution of the task (if the task is a scheduled task) is arrived, or any combination thereof. The task may be for one of deletion and backup, or for both deletion and backup, depending on the user's selections made at block 402. Thus, the task may call social network content deletion module 315, or social network content backup module 316, or both of these two modules.

In some situations, block 406 may be invoked immediately after block 403 without seeing any of blocks 404 and 405 being carried out. For example, if the user selects the “BOMB” option or selects the “SAVE” option without specifying daily automatic backup, block 406 may be invoked immediately after block 403, since under that circumstance, there is need to schedule any recurring backup tasks. After the execution of the task, the status (such as “complete” or “failure”) of the execution, along with other related information, may be stored in DS 302 by backend system 102, so that backend system 102 may later provide history information regarding executed tasks to the user via one or more UIs displayed by client application 206. FIG. 5K shows an exemplary UI providing history information regarding executed tasks.

At block 407, if a user has selected backing up of SNG contents, a user may download backed up SNG contents from backend system 102 via client application 206 after the corresponding backup task has been completed. Specifically, backend system 102, upon executing a backup task on behalf of the user, retrievably stores the backed-up SNG contents in either DS 302 or other internal or external storage devices (not shown). Backend system 102 may provide the user with status information about backup tasks that have been executed and allow the user to download backed-up SNG contents associated therewith via an UI displayed by client application 206.

FIG. 5L shows an exemplary UI that enables the user to download backed up SNG contents. For each completed backup task, the displayed UI include a clickable button labeled “download” which, when clicked, causes a download request (for downloading backed-up SNG contents associated with the backup task) to be sent to backend system 102 (via client application 206). Upon receiving the download request, backend system 102 may retrieve the previously stored backed-up SNG contents, form an aggregate file (such as a zip file) incorporating all the retrieved backed-up SNG contents, and enables the user to download the aggregate file. The user may then store the downloaded aggregate file in, e.g. storage module 220 for personal use.

FIGS. 6A-C are flowcharts each exemplifying an implementation of block 406 of FIG. 4 (in connection with backend system 102 executing a task of deleting or backing-up user-selected SNG contents).

FIG. 6A is a flowchart exemplifying an implementation of block 406 by backend system 102 on behalf of a user when backend system 102 cannot directly access the internal system (such as the database) of an SNP 103. At block 601, backend system 102 programmatically logs into an SNP 103 on behalf of the user so as to access the user's account with the SNP. Backend system 102 may do the programmatic login by sending a login web request with the user's login credentials (such as user name and password) for log into the SNP which the user has provided to backend system 102.

At block 602, backend system 102 accesses SNG contents of user from SN provider on behalf of the user, parses and analyzes received contents (such as HTML pages) so as to locate target SNG contents.

Typically, a SNP has an internal system to organize SNG contents of a user and identify each SNG content item of the user. As an example, different types of SNG contents may be placed under different categories. Under each category, there may be one or more sub-categories under which a SNG content item may be placed. Each category may be identified by certain mechanism, such as by name or by assigned category ID. So may be each sub-category and each SNG content item. For example, a sub-category may be identified by a unique ID, and a content item may also be identified by unique ID.

A content (such as a web page) of an SNP can usually be programmatically accessed via a corresponding URL or a corresponding protocol message (sent to the domain address of the SNP) conforming to a protocol method (such as “GET” or “POST” of HTTP or HTTPS). Thus, a top level or high-level category can usually be accessed, via a known corresponding URL a corresponding protocol message, in the form of, e.g. a web page. Through the web page corresponding to the high-level category, information about each sub-category (if there is any) or each content item under the high-level category may be accessed through parsing and analyzing the web page. Thus, by accessing web pages of respective categories or sub-categories one level at a time (or, in other words, one page at a time), information about an individual content item—such as the time which the content item is created, the size of the content item, the ID uniquely identifying the content item, and so on—may be accessed.

Once information about an individual SNG content item becomes available, the information can be used to decide whether the content item is a target content item. For example, information about an individual SNG content item usually includes the creation time and/or update time. The creation or update time may then be checked against the timeframe criterion set for target SNG content item. If the creation or update time meets the timeframe criterion, then the SNG content item will be decided as a target SNG item (for deletion or backup). Information about an individual SNG content item may also include information identifying the SNG content item (hereinafter referred to as “identification information”), such as an ID assigned to the SNG content item. The identification information of the SNG content item can be used to form a corresponding URL or corresponding protocol message that can be used to directly access, download, or delete the SNG content item. As readily appreciated by a skilled artisan, programmatically using the corresponding URL or corresponding protocol message to access, download or delete the SNG content item is equivalent of clicking a corresponding link or button to access, download or delete the SNG content item, as typically provided to a user using web browser to manually access, download or delete the SNG content item.

Thus, in one embodiment, to locate, for example, one or more target pictures, backend system 102, after logging into an SNP and getting in a session established by the SNP, may first access, e.g., a high-level “albums” category by first formulating a corresponding URL or a corresponding protocol message and then using the formed corresponding URL or corresponding protocol message to receive the content of the “albums” category in the form of, e.g., a web page. Then, backend system 102 may parse and analyze the “albums” category content (such as a web page) to get information about each album (in the “albums” category), including for example, ID, name, creation time, update time, and photo count of the album. If, e.g., the time information about the album indicates that none of the photos in the album would be target photos (for deletion or backup), further accessing the album may not be needed. Otherwise, backend system 102 uses the obtained information about the album to form a corresponding URL or corresponding protocol message so as to access the content of the particular “album” sub-category in the form of, e.g. a web page. Once again, backend system 102 may parse and analyze the category content (such as a category web page) to get information about each picture in the particular “album”, including, for example, ID, size, name, creation time of the picture. Using the obtained information about each picture, backend system 102 can decide whether a particular picture is a target picture for deletion. With the above-described repetitions, backend system 102 may locate all target pictures. Using the same or similar approach and repetitions, backend system 102 may locate all target SNG contents.

At block 603, if the task includes backup, for each located target SNG content item, backend system 102 forms a corresponding URL or a corresponding protocol message, and uses the formed URL or protocol message to receive or download the content of the SNG content item, and subsequently organize and save received or downloaded SNG contents in a manner suitable for user download. Specifically, once backend system 102 determines an item to be a target SNG content item and obtains information about the target SNG content item, backend system 102, using the information about the target SNG content item (such as identification information or name of the target SNG content item), may form a corresponding URL or corresponding protocol message which backend system 102 can use to programmatically receive or download the content of the target SNG content item from the SNP.

As a skilled artisan readily appreciates, using the corresponding URL or corresponding protocol message to programmatically receive or download the content of the target SNG content item is equivalent of clicking a corresponding link or button (appeared on a web page of the SNP) to receive or download the same target SNG content item. Typically, if a user manually receives or downloads the content of the target SNG content item, the user would have needed to navigate the SNP to first get to a web page through which the user can have access to a specific link (or button) directed to the target SNG content item, and then manually click that link in order to receive or download the target SNG content item. Thus, what backend system 102 does to accomplish the same is programmatically forming a URL or protocol message same as the URL or the protocol message that would have been sent to the domain address of SNP as a result of the user clicking that link, and then sending the formed URL or protocol message to the domain address of SNP to achieve receiving or downloading the content of the target SNG content item.

Using the same approach disclosed above for each SNG content item, backend system 102 may receive or download the contents of all the target SNG content items. Backend system 102 may subsequently organize and save received or downloaded SNG contents in a manner suitable for user download. In one implementation, backend system 102 may organize and save the received or downloaded SNG contents in a zip file. The zip file may be organized as having a set of directories each corresponding to a type of SNG content, with SNG contents of a particular type being placed in the directory corresponding to the type. Also, received or downloaded SNG contents of a same type may be arranged or encoded in a manner that the contents can be viewed through custom viewing software programs.

At block 604, if the task includes deletion, for each located target SNG content item, backend system 102 forms a corresponding URL or protocol message, and uses the formed corresponding URL or protocol message to delete the target SNG content item. This block is similar to block 603, except that the corresponding URL or corresponding protocol message is specifically formed to effectuate the deletion of the target SNG content item. In other words, what backend system 102 does to accomplish the same is programmatically forming a URL or protocol message same as the URL or the protocol message that would have been sent to the domain address of SNP as a result of the user clicking a link appeared (e.g. on a web page) for deleting a target SNG content item, and then sending the formed URL or protocol message to the domain address of SNP to achieve the deletion of the target SNG content item.

Although the flowchart of FIG. 6A may suggest that block 603 or 604 may take place after block 602, there is no specific order among blocks 602, 603 and 604. In particular, each of blocks 602, 603 or 604 may comprise sub-blocks which may be executed at different times. For example, some sub-blocks of block 602 may be executed after some sub-blocks of blocks 603 or 604 if backend system 102 chooses to backup or delete one located target SNG content item before locating another target SNG content item.

FIG. 6B is a flowchart exemplifying an implementation of block 406 alternate or in addition to the implementation of block 406 exemplified in FIG. 6C (by backend system 102 on behalf of a user) when backend system 102 cannot directly access the internal system of an SNP 103.

At block 621, backend system 102 retrieves a stored access token provided by the SNP for accessing the user's SNG contents.

At block 622, if the task includes backup, backend system 102 uses the access token to call APIs of the SNP to first locate target SNG content items, and then acquire the contents of the located target SNG content item. Subsequently, backend system 102 organizes and saves the acquired target SNG contents in a manner suitable for user download.

At block 623, if the task includes deletion, backend system 102 uses the access token to call APIs of the SNP to first locate target SNG content items, and then delete the located target SNG content items.

FIG. 6C is a flowchart exemplifying an implementation of block 406 by backend system 102 on behalf of a user) when backend system 102 either has direct access to the internal system of an SNP 103 or is part of the SNP.

At block 641, if the task includes backup, backend system 102 retrieves target SNG contents from the database of the SNP, and saves retrieved target SNG contents in a manner suitable for user download.

At block 642, if the task includes deletion, backend system 102 deletes target SNG contents from the database of the SNP using known database commands.

The blocks and steps described and the UI exemplified in connection with the embodiments disclosed herein and within the scope of the present disclosure can be embodied in one or more software modules executed by a processor. The one or more software modules can reside in one or more computer readable media. Such computer readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium.

While the disclosure has been described with reference to exemplary embodiments, it will be understood by those skilled in the art that various changes may be made and equivalents may be substituted for elements thereof without departing from the scope of the disclosure. In addition, many modifications may be made to adapt a particular system, device or component thereof to the teachings of the disclosure without departing from the essential scope thereof.

What is claimed is:

1. A system of backing-up and deleting social networking generated (SNG) contents of a user generated by social networking activities conducted through a social network provider (SNP) with which the user has an account, the system comprising:
means for setting criteria for target SNG contents to be either backed-up or deleted, said criteria including at least one timeframe criterion and content type criterion;
execution means for programmatically downloading or deleting target SNG contents stored in the SNP; and
means for invoking the execution means;
